(19) United States
(12) Patent Application Publication
(10) Pub. No.: US 2007/0262226 A1
(43) Pub. Date: Nov. 15, 2007

(54) ORGANIZER

(76) Inventor: ANDREW C. FORGAY, SALISBURY, MD (US)

Correspondence Address: DLA PIPER US LLP, P. O. BOX 9271, RESTON, VA, 20195, US

(21) Appl. No.: 11/746,871

(22) Filed: May 10, 2007

Related U.S. Application Data
(60) Provisional application No. 60/800,040, filed on May 15, 2006.

(51) Int. Cl. A47G 29/00; F16M 11/00

(52) U.S. Cl. 248/693

(57) ABSTRACT

An organizer, comprising: a strap made of a soft material; a strap securing device securing the strap to a surface; and an item securing device securing an item to the strap. The organizer is used to neatly store one or more items on a surface

This application claims priority to Provisional Application No. 60/800,040, filed on May 15, 2006, which is herein incorporated by reference.

### BRIEF DESCRIPTION OF THE FIGURES

FIG. 1 illustrates an organizer 100, according to one embodiment of the invention.

FIGS. 2-3 illustrate a strap securing device 105, according to one embodiment.

FIG. 4 illustrates a strap 110, according to one embodiment.

FIGS. 5-6 illustrate an item securing device 115, according to one embodiment.

### DESCRIPTION OF EMBODIMENTS OF THE INVENTION

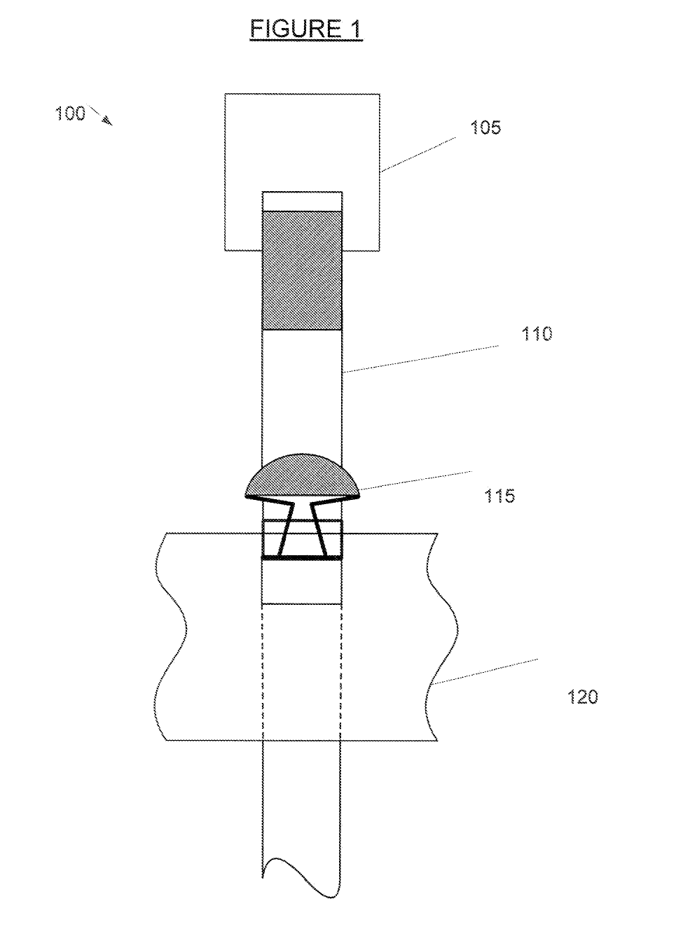

FIG. 1 illustrates a front view of organizer 100, according to one embodiment of the invention. In one embodiment, the organizer 100 is used to neatly store one or more items 120, such as packaged items (e.g., chips, pretzels, soup packets). Those skilled in the art will see that the organizer 100 is not limited to storing packaged items, and can be used to store items 120 in any container (e.g., cans), as well as items 120 that are not in a container (e.g., fruit, vegetables, note pads, paper, cards). In one embodiment, the organizer 100 may be used with items 120 that have bulky and/or irregular surfaces that do not lend themselves to stacking or firm placement on shelves.

In one embodiment, the organizer 100 can be used to store items 120 along a vertical surface (e.g., a door or wall) in a pantry or cupboard. However, it should be noted that the organizer 100 can be used to store items 120 along any surface (e.g., vertical, horizontal, slanted.), or from any point (e.g., hanging from a ceiling or door frame, attached to a suitcase or other item) in any location (e.g., vehicle, home, office).

In one embodiment, the organizer 100 comprises a strap 110 secured to a support (e.g., a surface). For example, the strap 110 can be secured to the top of a door, wrapped around a surface, etc. In one embodiment, the strap is made out of a soft, flexible material. In one embodiment, a strap securing device 105 can be utilized to connect the strap 110 to the surface. However, it should be noted that, in one embodiment, the strap 110 can also be directly connected to the surface. One or more item securing devices 115 are attached to the strap 110, and are utilized to hold items 120.

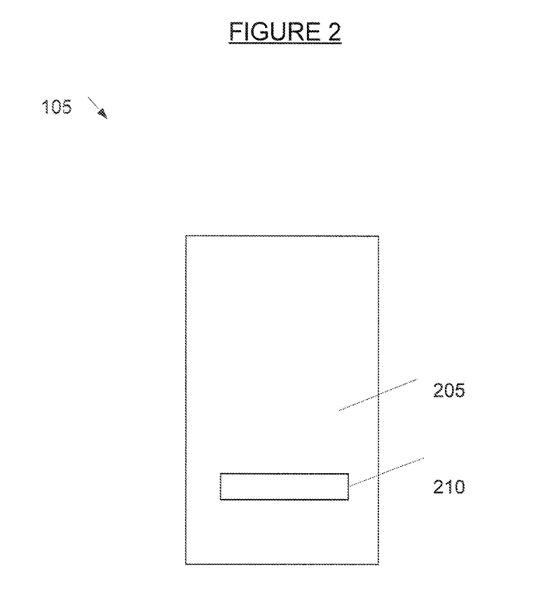

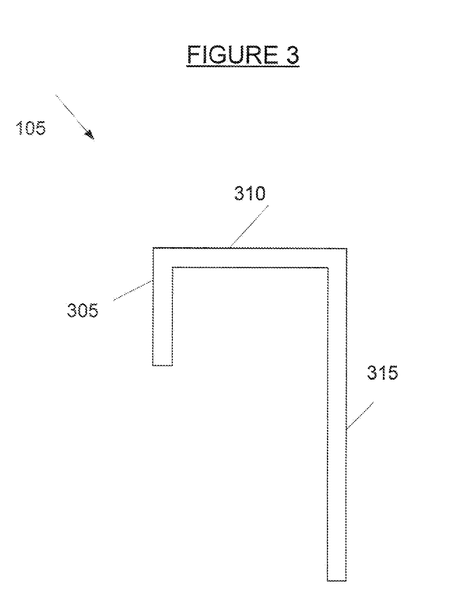

In one embodiment, the organizer 100 is secured using a strap securing device 105. For example, in one embodiment, one or two plastic or metal hooks that fit over the top and/or bottom of the door are used as the securing devices. FIG. 2 illustrates a front view of a strap securing device 105, according to one embodiment. The strap securing device 105 can have a surface portion 205 which can be placed on a surface, and a strap opening 210, which allows the strap 110 to be connected to the strap securing device 105. In one embodiment, the strap securing device 105 can be curved, straight, or of any shape. FIG. 3 illustrates a side view of a strap securing device 105 which comprises three straight segments 305, 310, and 315, intersecting at ninety degrees to allow for a flush fit over door ends. It should be noted that multiple other types of strap securing devices 105 can be used. For example, the strap 110 can be secured to the surface through use of nails, screwed-in mounting plates, etc. As another example, the strap 110 could be secured to the surface using adhesive or suction cups.

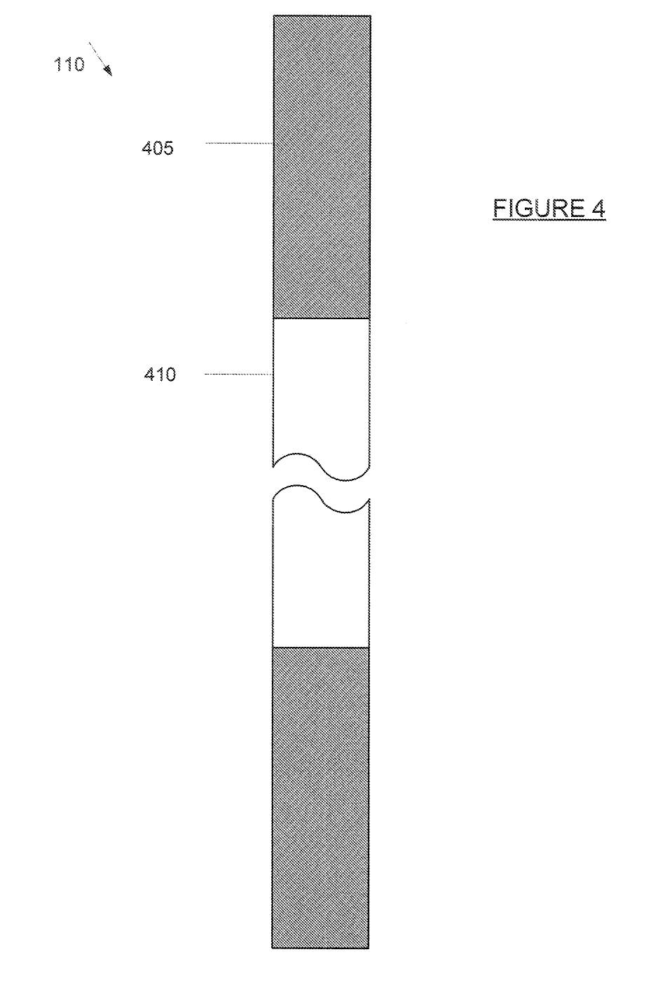

In one embodiment, the strap 110 is inserted or connected to the strap securing device 105. In one embodiment, the strap 110 is pulled flat, and doubled back over itself so that the strap 110 connects securely with itself with the application of light pressure. In one embodiment the strap 110 is a hook-and-loop strap (e.g., see hook material 405 and loop material 410 of FIG. 4), which is inserted through the strap opening 210, pulled tight, and doubled back over itself so that the hook-and-loop portions connect securely to each other. In one embodiment, the hook material 405 and loop material 410 of the strap 110 comprise securing material (e.g., Velcro™) allowing the strap to connect with itself with light pressure. Those skilled in the art will see that a multitude of other securing materials or devices (e.g., buttons, snaps) or straps 110 may be used such that the strap is able to connect securely with itself. In addition, those of ordinary skill in the art will see that the strap 110 does not need to loop over and connect with itself, and that it could hand down freely while attached to the surface by the strap securing device 105.

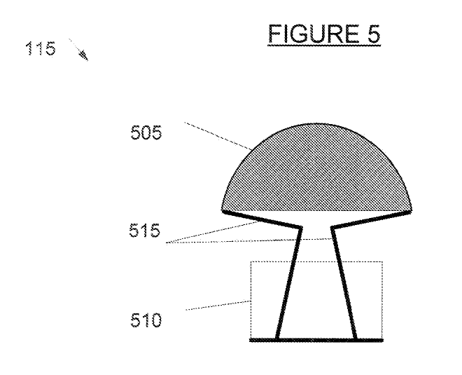

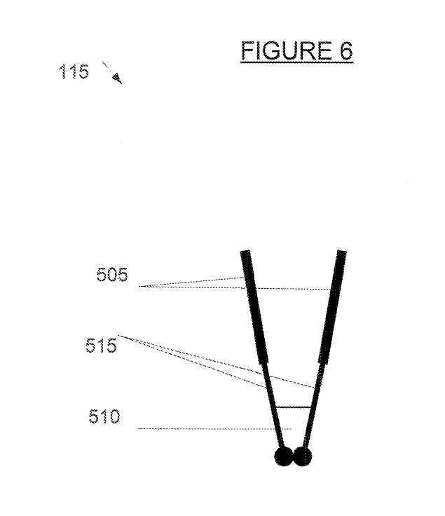

FIGS. 5-6 illustrate an item securing device 115, according to one embodiment of the invention. Any item securing device 115 can be used with the organizer 100, such that the item securing device 115 secures one or more items 120 to the strap 110. When an item is held by the item securing device it can be neatly and securely stored along the surface. Multiple items 120 can easily be stored in this fashion along one strap. Multiple types of item securing devices can also be used.

In one embodiment, clips (e.g., binder clips) of one or more sizes are used as item securing devices 115. In the embodiment illustrated in FIGS. 5-6, if a clip is used as the item securing device 115, and a hook-and-loop strap 110 is utilized, one or both arms of each clip can be surfaced with “hook” material. The binder clips are attached to the vertical strap by mating their respective hook and loop surfaces. FIG. 5 illustrates a front view of an item securing device 115 which is a binder clip, according to one embodiment. The binder clip can include a securing material 505, clip arms 515, and a clip base 510. FIG. 6 illustrates a side view of the binder clip, which illustrates the side view of securing material 515, clip arms 515, and clip base 510, according to one embodiment.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that any figures which highlight the functionality and advantages, are presented for example purposes only. The disclosed architecture is sufficiently flexible and configurable, such that it may be utilized in ways other than that shown. For example, the described elements of the organizer 100 may be only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

1. An organizer, comprising:
a strap made of a soft material;
a strap securing device securing the strap to a support; and
an item securing device securing an item to the strap.

2. The organizer of claim 1, wherein the strap is doubled back over itself and connects with itself.

3. The organizer of claim 1, wherein the strap connects with itself using Velcro.

4. The organizer of claim 1, wherein the strap securing device comprise a clip; a nail; a mounting plate; an adhesive; a suction cup; a hook; or Velcro; or any combination of two or more thereof.

5. The organizer of claim 1, wherein the item securing device is a clip; a mounting plate; an adhesive; a suction cup; a hook; or Velcro; or any combination of two or more thereof.

6. The organizer of claim 1, wherein the item secured to the strap is a bin; a shelf; a container; or any combination thereof.

7. The organizer of claim 1, wherein an additional item is stored on and/or in the item secured to the strap.

8. The organizer of claim 1, wherein the support is a surface, a door; a wall; a counter; or any combination of two or more thereof.

9. The organizer of claim 1, wherein multiple items are held by the item securing device.

10. The organizer of claim 1, wherein multiple item securing devices are utilized to secure items to the strap.

11. The organizer of claim 1, wherein the strap is not doubled back over itself.

12. The organizer of claim 1, wherein the strap hangs freely while secured to the support by the strap securing device.

13. The organizer of claim 1, wherein the strap is flexible.
